(19) United States
(12) Patent Application Publication
(10) Pub. No.: US 2011/0150262 A1
(43) Pub. Date: Jun. 23, 2011

(54) HEADSET

(75) Inventors: Hidekazu Nakama, San Diego, CA (US); Atsushi Inoue, Tokyo (JP); Koji Morihiro, Tokyo (JP)

(73) Assignee: HaaLee Inc., Tokyo (JP)

(21) Appl. No.: 12/973,031

(22) Filed: Dec. 20, 2010

Related U.S. Application Data
(60) Provisional application No. 61/289,023, filed on Dec. 22, 2009.

(30) Foreign Application Priority Data
Jan. 8, 2010 (JP) 2010-002823

(51) Int. Cl. H04R 1/10

(52) U.S. Cl. 381/370

(57) ABSTRACT

A headset of the invention can achieve high-quality sound reproduction over a wide band while allowing sound from the outside to be sufficiently heard. The headset includes at least one vibrator configured to vibrate in accordance with an electric signal. The headset also includes at least one diaphragm each being associated with the respective vibrator. The headset also includes a holding unit that, when worn on a head of a user, holds the diaphragm such that at least part of the diaphragm is spaced from a side surface of the head by a predetermined distance. When the headset has two diaphragms, the holding unit may also function as a linking member that links the two diaphragms.

### CROSS REFERENCES TO RELATED APPLICATIONS

This application claims the benefit under 35 U.S.C. Section 119(e) to U.S. Provisional Application No. 61/289,023 filed Dec. 22, 2009, the entire contents and file wrapper of which are hereby incorporated by reference for all purposes into this application, and also claims the benefit under 35 U.S.C. Section 119(a) and (b) of Japanese Patent Application No. 2010-2823 filed Jan. 8, 2010, the entire contents of which are hereby incorporated by reference for all purposes into this application.

### FIELD OF THE INVENTION

The present invention relates to a headset for listening to music, etc.

### SUMMARY OF THE INVENTION

Small-size earphones fitted in ear canals are used widely as reproducing devices for personally listening to music with portable music players, etc. (see, for example, Japanese Patent Application Publication (Kokai) No. 2009-212918). When using the earphones, it is difficult to hear ambient sound since ear canals are plugged. Thus, a voice from others is unnoticed, and warning sound is unnoticed. Therefore, the earphones are disadvantageous in outdoor use. The earphones are also disadvantageous when people wearing the earphones work together because they cannot hear other's voices. The earphone provides acoustic effects only in ear canals, which are extremely limited spaces. Thus, high-quality sound cannot be ensured over a wide frequency band. In particular, the sound quality is poor in the low-tone range as compared to larger speakers.

Headphones covering the entire ears are also used widely as reproducing devices (see, for example, Japanese Patent Application Kokai No. 2009-284169). Since the headphones can ensure an acoustic space to some extent, higher quality sound is realized over a wider frequency band as compared to the earphones. However, the headphones are configured to cover the entire ears and sound from the outside is shut off. Thus, a user wearing the headphones does not notice warning sound or the like.

Bone-conduction headsets are also commercialized (see, for example, Japanese Patent Application Kokai No. 2009-111820). The bone-conduction headset can transmit sound without plugging ears in theory, but a conducting medium of sound is bone, which is solid, instead of a gas (air). Thus, the frequency characteristics of the sound conduction path are not flat and it is difficult to achieve high-quality sound reproduction over a wide band. Since the bone-conduction headset causes a solid to vibrate, more energy is required as compared to an apparatus causing a gas to vibrate (such as earphones). Therefore, the headset must be equipped with a higher-capacity battery, which is usually large and heavy. Thus, it is difficult to downsize the headset.

Electronic circuits and parts are recently further downsized. Small-size music reproducing devices and portable telephones having a music reproducing function are commercialized. There is an increasing demand for easily carrying these devices to enjoy music in high quality regardless of time and place.

However, as understood from the foregoing, when using the above-described reproducing devices, high-quality reproduction cannot be achieved over a wide band and sound from the outside cannot sufficiently be heard.

One object of the present invention is to provide a headset that is capable of achieving high-quality sound reproduction over a wide band while allowing a user to hear ambient sound sufficiently even when the user wears the headset on his/her head.

According to one aspect of the present invention, there is provided a headset that includes at least one vibrator configured to vibrate in accordance with an electric signal. The headset also includes at least one diaphragm each being associated with the respective vibrator. The headset also includes a holding unit (or linking unit) that, when worn on a head of a user, holds the diaphragm such that at least part of the diaphragm is spaced from a side surface of the head by a predetermined distance. Preferably the vibrator is supported by the diaphragm such that the vibrator does not contact with the side surface of the user's head when the user wears the headset.

The diaphragm may extend over an immediate lateral side of an ear canal of the user when the headset is worn on the head of the user. The vibrator may be fixed to the diaphragm and may be located at a position offset from an immediate lateral side of an ear canal of the user toward a front of the head of the user when the headset is worn on the head of the user. The vibrator may be fixed on that surface of the diaphragm that faces a side surface of the head when the headset is worn on the head of the user. The diaphragm may have a base portion to support the vibrator and may also have a sidewall formed along at least part of a peripheral edge of the base portion. The sidewall may have a first height in the vicinity of the vibrator and a second height in other parts of the sidewall, and the first height may be greater than the second height. The first height may be greater than a thickness of the vibrator.

The headset may have two diaphragms. The holding unit may also serve as a linking member that links the two diaphragms. The linking member may wrap around the head when worn on the head of the user.

The diaphragm may be rotatable about a predetermined holding position of the holding unit. The diaphragm may be provided on the holding unit and may be rotatable about a predetermined part of the holding unit. The vibrator may be fixed at a position offset from the center of rotation of the diaphragm. The headset may further include a signal supplying unit that changes a signal level of the electric signal depending on a rotational position of the diaphragm.

The headset may further include a sound leakage preventing member attached to the holding unit. The diaphragm may be movable between at least two positions relative to the sound leakage preventing member. One of the two positions may be a position where the diaphragm is closest to the sound leakage preventing member so that an ear of the user is covered by the sound leakage preventing member and the base portion and the sidewall of the diaphragm. The other position may be a position where the diaphragm is farthest from the sound leakage preventing member so that the ear of the user is not covered by the sound leakage preventing member and the base portion and the sidewall of the diaphragm.

The headset may further include a sound absorbing member provided in contact with the diaphragm.

The vibrator for use in the headset may include a frame (housing) that includes a vibration transmitting plate. The vibrator may also include a cylindrical yoke fixed to an inner wall of the frame by a movable support. The yoke has a bottom and a sidewall. The vibrator may also include a magnet fixed to the bottom of the yoke. The vibrator may also include a coil that surrounds at least part of a side surface of the magnet at one end thereof. The coil may be fixed to the vibration transmitting plate at the other end. The vibrator may further include a weight affixed to the magnet. The weight may be a magnetic body. The height of the sidewall of the yoke may be greater than a sum of a thickness of the magnet and a thickness of the weight.

According to the headset of the present invention, the high-quality sound reproduction can be achieved over a wide band and the ambient sound can sufficiently be heard by a user who wears the headset.

According to another aspect of the present invention, there is provided a headset that includes a generally U-shaped or C-shaped elongated member, and two vibration members (referred to as “diaphragms” in preferred embodiments) attached to ends of the elongated member. Each of the vibration members supports or houses an oscillating element (referred to as “vibrators” in preferred embodiments). One or two control units are mounted on the elongated member. When a user wears the headset, the elongated member extends around generally a rear half portion of a user's head. The end portions of the headset bend downward so that the end portions hook on user's ears. The vibration members extend generally backwards from the ends of the elongated member along the user's face to extend over the user's earholes. The ends of the elongated members are positioned forwards of the user's earholes. The oscillating elements do not close or overlap the user's earholes. The oscillating elements may or may not contact the user's face. When a user listens to music, the control units receive an electric signal representing the music from a remote music source by wire or wireless. The control units then supply the electric signal to the oscillating elements to cause the oscillating elements to vibrate. Because the oscillating elements are mounted on the vibration members, the vibration members vibrate as the oscillating elements vibrate. Vibrations of the vibration members are transmitted to user's ears via the air. The vibration members may or may not contact a user's face. Unlike a conventional headset, the vibration members of this invention do not close the user's entire ears. Also, the oscillating elements do not close the user's ears or earholes. The user's ears are open to the air. Therefore, the headset user can hear an outside sound (e.g., someone's talking voice, alarming buzzers, vehicle's horn or the like) while he/she is listening to the music. The positions of the vibration members and/or oscillating elements relative to the elongated member may be adjustable. A loudness (or volume) of the music may be changed as the positions of the vibration members and/or oscillating elements are changed.

These and other objects, aspects and advantages of the present invention will become apparent to those skilled in the art from the following detailed description when read and understood in conjunction with the accompanying drawings.

### BRIEF DESCRIPTION OF THE DRAWINGS

FIG. 1 illustrates a headset of a first embodiment of the invention;

FIG. 2 is a block diagram of a control unit for the headset of FIG. 1;

FIG. 3a shows a user's right ear and its vicinity when the headset of FIG. 1 is worn on a user's head;

FIG. 3b1 is a cross-sectional view of the headset of FIG. 1 taken along the line b1-b1;

FIG. 3b2 is a cross-sectional view of the headset of FIG. 1 taken along the line b2-b2;

FIG. 3c is a perspective view of a vibrator, a diaphragm, and a linking unit on the right side of the headset of FIG. 1 viewed from a user's head side;

FIG. 4a shows the right ear and its vicinity when the headset having another diaphragm is worn on the head;

FIG. 4b is a perspective view of the vibrator, the diaphragm, and the linking unit on the right side of the headset of FIG. 4a viewed from the user's head side;

FIG. 4c is a perspective view similar to FIG. 4b and illustrates a modification that includes a sliding mechanism provided on the diaphragm for adjusting a position of the vibrator;

FIG. 5a is a cross-sectional view near the right ear when the headset having another linking unit is worn on the head;

FIG. 5b is a cross-sectional view near the right ear when the headset having still another linking unit is worn on the head;

FIG. 6a is a cross-sectional view of a diaphragm with a sound absorbing member;

FIG. 6b illustrates an exploded perspective view of the diaphragm shown in FIG. 6a;

FIG. 7a illustrates a headset of a second embodiment of the invention in the open state (or open position);

FIG. 7b illustrates the headset of the second embodiment in the closed state (or closed position);

FIG. 8a shows the right ear and its vicinity when the headset of FIG. 7a is worn on the head in the open state;

FIG. 8b shows the right ear and its vicinity when the headset of FIG. 7b is worn in the closed state;

FIG. 9 is a perspective view of a headset of a third embodiment of the invention;

FIG. 10a shows the right ear and its vicinity when the headset of FIG. 9 is worn on the head in the open state;

FIG. 10b depicts the right ear and its vicinity when the headset of FIG. 9 is worn in the closed state;

FIG. 11a illustrates how sound volume is controlled in the open state of the headset of FIG. 9;

FIG. 11b illustrates how the sound volume is controlled in the closed state;

FIG. 12a is a diagram of another sound volume control in the open state of the headset of FIG. 9;

FIG. 12b is a diagram of another sound volume control in the closed state;

FIG. 13a1 illustrates a headset according to a fourth embodiment of the invention in the open state;

FIG. 13a2 is a perspective view of the headset of FIG. 13a1;

FIG. 13b1 shows the headset of FIG. 13a1 in the closed state;

FIG. 13b2 is a perspective view of the headset of FIG. 13b1;

FIG. 14a shows a headset according to a fifth embodiment of the invention when viewed from the front of the head;

FIG. 14b shows the headset of the fifth embodiment when viewed from the top;

FIG. 15 is a perspective view of a headset according to a sixth embodiment of the present invention;

FIG. 16 illustrates a cross-sectional view of a vibrator included in the headset; and

FIG. 17 illustrates an exploded cross-sectional view of parts of the vibrator shown in FIG. 16.

### DETAILED DESCRIPTION OF THE INVENTION

Embodiments according to the present invention will now be described in detail with reference to the accompanying drawings. Similar reference numerals and symbols designate similar elements in the different drawings.

### First Embodiment

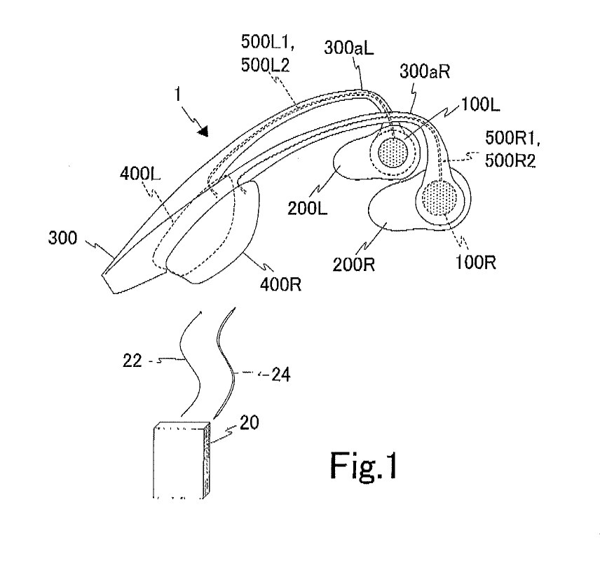

FIG. 1 depicts a headset 1 of the first embodiment of the present invention. The headset 1 includes vibrators 100R and 100L, diaphragms 200R and 200L, a linking unit (holding unit) 300, and control units 400R and 400L. The vibrator 100R and diaphragm 200R are used for the user's right ear, and the vibrator 100L and diaphragm 200L are used for the user's left ear. The diaphragms 200R and 200L are attached to opposite ends of the linking unit 300.

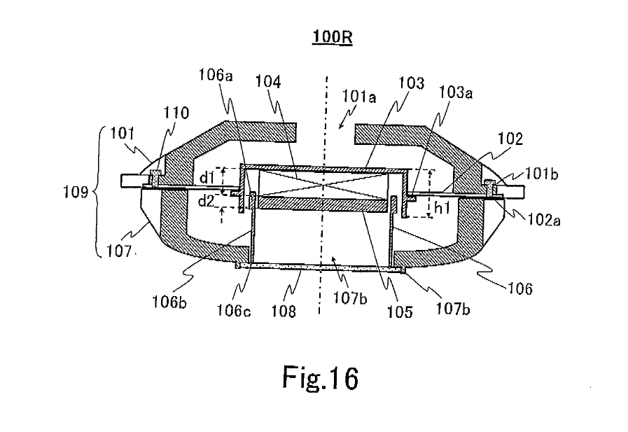

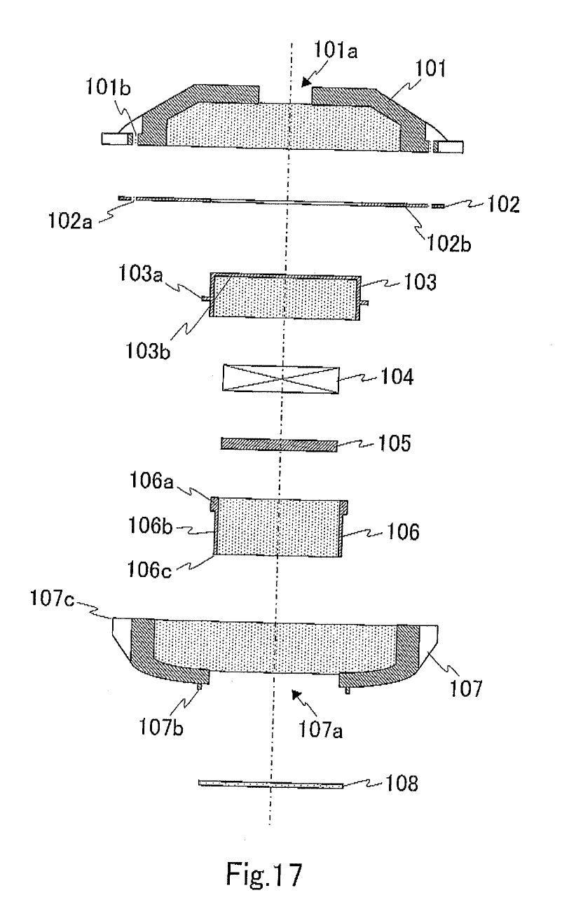

The vibrator 100R is configured to mechanically (or physically) vibrate in accordance with electric signals supplied from the outside. The electric signals are representative of, for example, music. The structure of the vibrator 100R will be described later (FIGS. 16 and 17). The right vibrator 100R is fixed to the inner surface of the right diaphragm 200R with an adhesive, for example. The left vibrator 100L has the same configuration as the vibrator 100R, and is fixed to the inner surface of the left diaphragm 200L.

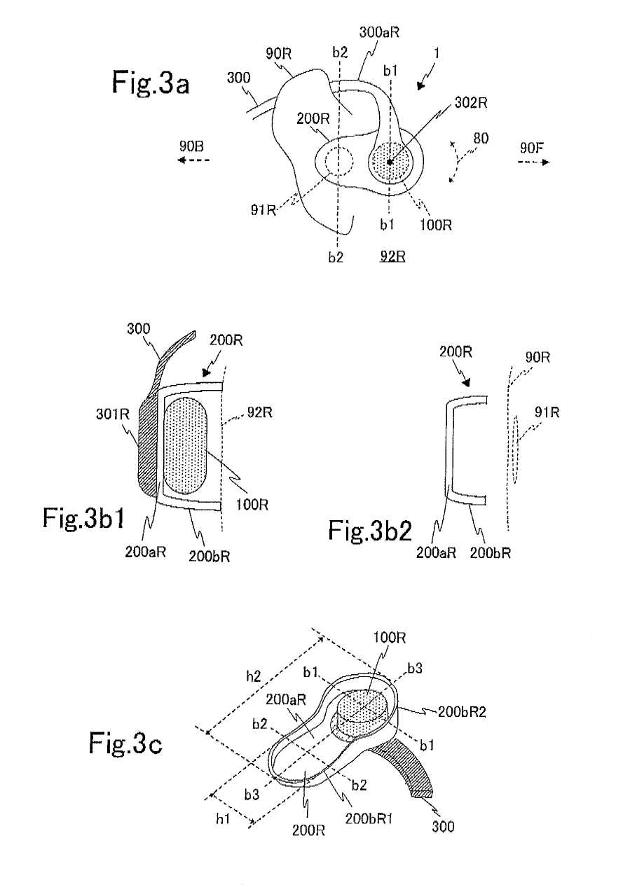

The diaphragm 200R is generally a plate made of, for example, plastic. One role of the diaphragm is to transmit the vibrations of the vibrator 100R to the ear canal of the right ear through aerial vibration. The shape of the diaphragm 200R will be described later (FIG. 3a to FIG. 3c). The diaphragm 200R is fixed, at its outer surface, to one end of the linking unit 300. The left diaphragm 200L has a role such as transmitting the vibrations of the vibrator 100L to the ear canal of the left ear through aerial vibration, and has the same configuration as the right diaphragm 200R.

The linking unit 300 is a generally C-shaped or U-shaped elongated member made of, for example, a material such as plastic. The linking unit 300 connects the right diaphragm 200R and the left diaphragm 200L to each other. The diaphragm 200R is fixed to one end of the linking unit 300 and the diaphragm 200L is fixed to the other end of the linking unit 300. The linking unit has a shape that wraps around the back of the head from one end of the linking unit to the other end when a user wears the headset 1 on the head. When wearing the headset 1, a curved portion 300aR near the right diaphragm 200R and a curved portion 300aL near the left diaphragm 200L of the linking unit 300 are hooked on the right and left ears, respectively. Because the linking unit 300 supports (or holds) the diaphragms 200R and 200L relative to the user's head or ears, the linking unit 300 may be referred to as the holding unit. It should be noted that the shape of the linking unit 300 is not limited to that shown in FIG. 1. For example, the linking unit 300 may wrap around the top of the user's head when the headset is worn.

The control unit 400R supplies the right vibrator 100R with electric signals representative of music, for example. The control unit is covered with a member such as plastic, for example, (i.e., the control unit has a plastic casing) and attached to the linking unit 300.

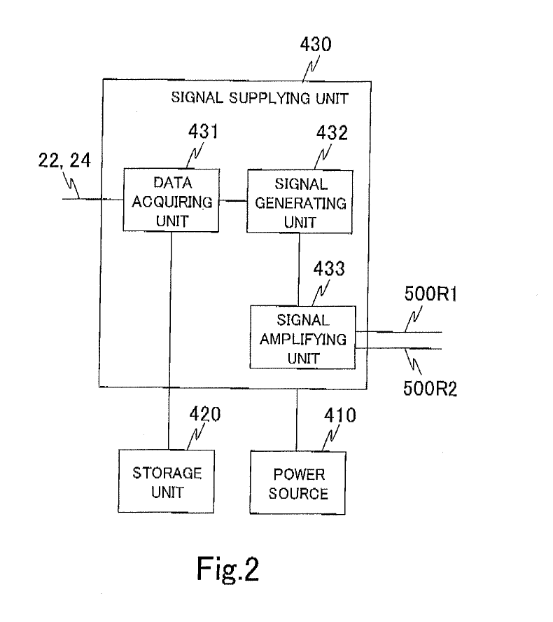

FIG. 2 is a block diagram that shows a configuration of the control unit 400R. The control unit 400R includes a power source unit 410, a storage unit 420, and a signal supplying unit 430.

The power source unit 410 is, for example, a power source such as a small battery supplying electric power to the signal supplying unit 430.

The storage unit 420 is, for example, a storage medium such as a hard disc storing data such as music data in MP3 format or any other suitable format.

The signal supplying unit 430 supplies the vibrator 100R with the electric signals representative of music. The signal supplying unit 430 includes a data acquiring unit 431, a signal generating unit 432, and a signal, amplifying unit 433. The signal supplying unit 430 is made up of a semiconductor chip, for example.

The data acquiring unit 431 acquires music data in the form of wireless signal 22 (FIG. 1) such as a Bluetooth signal from a reproducing device 20 (FIG. 1) remote from the headset 1. Alternatively the data acquiring unit 431 may acquire the music data through an audio cable 24 (FIG. 1) instead of the wireless signal 22. The data acquiring unit 431 may acquire music data stored in advance in the storage unit 420. It should be noted that the signal 22 (or 24) is not limited to music. The data receiving unit 431 can receive any suitable signals from any sources through wires or wireless communications.

The signal generating unit 432 generates electric signals representative of music based on the music data received at the data acquiring unit 431.

The amplifying unit 433 is an amplifier that amplifies the electric signals generated by the signal generating unit 432. The amplifying unit 433 supplies the amplified electric signals to the vibrator 100R via metal wirings 500R1 and 500R2 made of, for example, copper. The metal wirings 500R1 and 500R2 extend in the linking unit 300.

The left control unit 400L for supplying the electric signals to the left vibrator 100L has the same configuration as the right control unit 400R. It should be noted that the power source unit 410 and the storage unit 420 may be used in common between the left and right sides. It should also be noted that the control units 400L and 400R may be combined to a single control unit.

FIG. 3a depicts the user's right ear 90R and its vicinity when the headset 1 is worn on the head. In the following description, the direction of the arrow 90F and the direction of the arrow 90B will be referred to as the front side (or front direction) of the head and the rear side (or rear direction) of the head, respectively. A user wears the headset 1 on his/her head by hooking the right curved portion 300aR and the left curved portion 300aL (not shown) of the linking unit 300 on the right ear 90R and the left ear (not shown), respectively. When the headset 1 is worn on the head, the vibrator 100R is located at a position offset toward the front side of the head from an ear canal 91R instead of an immediate lateral side of the ear canal 91R. This is the initial position of the vibrator 100R. The diaphragm 200R is formed to extend from the vibrator-fixing portion in the direction of the ear canal 91R, i.e., to the rear side of the head. In other words, the diaphragm 200R extends in the direction away from the vibrator-fixing position. The diaphragm 200R is formed such that a portion thereof covers the immediate lateral side of the ear canal 91R at a certain distance from the ear canal 91R without covering the entire ear 90R.

A length of that portion of the linking unit 300 which extends from the corner 300aR to the diaphragm mounting position 302R may be longer or shorter than the length shown in FIG. 3a. If this portion is longer than the illustrated length (FIG. 3a), the vibrator 100R may be located on the front obliquely lower side of the head, when compared with the location in FIG. 3a. In this case, the diaphragm 200R may be configured to be rotatable in the directions indicated by the double-head arrow 80 about a shaft 302R of the linking unit 300 so as to adjust the positional relationship between the vibrator 100R and the ear canal 91R.

FIG. 3b1 is a cross-sectional view of the headset 1 taken along the line b1-b1 in FIG. 3a. The diaphragm 200R has a base portion 200aR and a sidewall 200bR. With regard to two surfaces of the base portion 200aR, a surface on the side with the sidewall 200bR formed will hereinafter be referred to as an inner surface and a surface opposite to the inner surface will be referred to as an outer surface. Within the sidewall. 200bR, a sidewall on the rear side of the head will hereinafter be referred to as a sidewall 200bR1 (FIG. 3b2) and a sidewall on the front side of the head is referred to as a sidewall 200bR2. As shown in FIG. 3b1, the vibrator 100R is fixed to the inner surface of the diaphragm 200R. The outer surface of the diaphragm 200R is connected to an end 301R of the linking unit 300. The sidewall 200bR is taller (greater) than the thickness of the vibrator 100R so that when the headset 1 is worn on the head, the vibrator 100R does not contact with a head side surface 92R although the sidewall 200bR contacts with the head side surface 92R.

FIG. 3b2 is a cross-sectional view of the headset 1 taken along the line b2-b2 in FIG. 3a. As shown in FIG. 3b2, the base portion 200aR and the sidewall 200bR1 do not contact with the ear 90R and the ear canal 91R, and an open space is left between the diaphragm 200R, and the ear 90R and the ear canal 91R.

FIG. 3c is a perspective view of the vibrator 100R, the diaphragm 200R, and the linking unit 300 viewed from the user's head side 92R (FIG. 3b1). One surface of the vibrator 100R is fixed to the inner surface of the diaphragm 200R with an adhesive, for example. The other surface of the vibrator 100R is exposed and is visually recognizable from the outside. The diaphragm 200R is formed such that a width h2 in the direction of one axis (e.g., axis b3-b3) is greater than a width h1 in the direction of another axis (e.g., axis b1-b1 or b2-b2) intersecting with the axis b3-b3 at a right angle. As depicted in FIG. 3c, the width h1 is not constant, i.e., the shape of the diaphragm 200R has a larger portion in the width h1 direction (e.g., portion around the axis b1-b1) than other portions in the width h1 direction (e.g., portions around the axis b2-b2). The diaphragm 200R may have any suitable shape, including a circular, oval, rectangular, other polygonal shapes or an arbitrarily deformed shape thereof as long as a portion of the diaphragm 200R covers at least a portion of the immediate lateral side of the ear canal 91R without covering the entire ear 90R when the headset 1 is worn on the user's head. The diaphragm may not necessarily have a flat plate shape, i.e., it may bend toward the inner surface side, for example. The exposed side of the vibrator 100R of FIG. 3c may be covered with a member made from the same material as the diaphragm 200R.

The sidewall 200bR1 is lower (shorter) than the sidewall 200bR2. In other words, the sidewall of the diaphragm 200R has a first height 200bR2 in the vicinity of the vibrator and a second height 200bR1 in other parts of the sidewall, and the first height 200bR2 is greater than the second height 200bR1. Because of this configuration, when the first sidewall 200bR2 contacts with the head side surface 92R (FIG. 3a and FIG. 3b1), the second sidewall 200bR1 does not contact with the head side surface 92R and does not contact with the ear 90R and the ear canal 91R. As a result, the open space is left between the base portion 200aR of the diaphragm 200R and the head side surface 92R, between the diaphragm base portion 200aR and the ear 90R, and between the diaphragm base portion 200aR and the ear canal 91R. It should be noted that in consideration of user's feeling at the head side surface 92R when he/she wears the headset, the thickness of the sidewall 200bR2 may be made thicker or thinner than that depicted in FIG. 3c. Also, the sidewall 200bR2 may be rounded at a portion coming into contact with the head side surface 92R. The sidewalls 200bR1 and 200bR2 may not necessarily be of the same material as the base portion 200aR. For example, the sidewall 200bR may be a plastic member. This plastic member may possess sound insulating properties and have a certain thickness.

The operation of the headset 1 will hereinafter be described with reference to FIG. 1 to FIG. 3c. First, a user wears the headset 1 on the head. A reproduction button (not depicted) of the reproducing device 20 is then pressed to reproduce music. The data acquiring unit 431 of the headset 1 receives music data to be reproduced from the reproducing device 20 through the cable 24, for example. The signal generating unit 432 generates electric signals representative of music based on the music data acquired by the data acquiring unit 431. The amplifying unit 433 amplifies the electric signals generated by the signal, generating unit 432 and supplies the electric signals to the vibrator 100R via the metal wirings 50081 and 500R2 disposed in the linking unit 300 and to the vibrator 100L via the metal wirings 500L1 and 500L2.

The vibrators 100R and 100L vibrate in accordance with the electronic signals from the amplifying unit 433. The vibrations of the vibrators cause the diaphragm 200R associated with the vibrator 100R to vibrate and the diaphragm 200L associated with the vibrator 100L to vibrate. These vibrations arrive at the user's right ear 90R through the medium of air between the right diaphragm 200R and the right ear 90R and arrive at the user's left ear (not depicted) through the medium of air between the left diaphragm 200L and the left ear.

By configuring the headset 1 in the above-described manner, the following advantages are obtained. First, since the diaphragms 200R and 200L do not entirely cover (close, envelop) the right ear 90R and the left ear (not shown), the user of the headset 1 can hear ambient sound and voice, for example, warning sound or a voice from others. Thus, the headset can be used outdoors without problems and at the time of working in a group without problems.

Second, the diaphragms 200R and 200L do not contact with the right ear 90R and the left ear (not shown), respectively, and the open spaces (or no closed spaces) are intentionally left between the diaphragm 200R and the right ear 90R and between the diaphragm 200L and the left ear. When the headset is worn on the user's head, the holding unit supports the diaphragms such that at least part of each diaphragm is spaced from the user's head face. Therefore, vibrant sound can be reproduced as if the sound was heard in a wider space instead of muffled sound of when using ordinary earphones or headphones. Since the open spaces to the environment are left, the headset 1 can reproduce high-quality low-frequency sounds. Thus, high-quality sounds can be reproduced by the handset of the invention over a wider band from a low frequency to a high frequency. It should be recalled that ordinary earphones particularly deteriorate sound quality in a low frequency range.

Third, since the vibrators 100R and 100L are not allowed to contact with the right head side surface 92R and the left head side surface (not shown), a user does not feel discomfort due to the vibrations of the vibrators. Since the vibrators 100R and 100L are not allowed to contact with the right head side surface 92R and the left head side surface and the vibrations are transmitted through the medium of air to the right ear 90R and the left ear (not shown), high-quality sounds can be reproduced over a wider band as compared to the case of transmission through the medium of a solid having non-flat frequency characteristics such as skin and bone as in a bone-conduction headset. Since the headset 1 does not cause a bone and skin, which are solid, to vibrate, power consumption can be reduced as compared to a bone-conduction headset. This enables use of a smaller battery, and the headset 1 can be made light and compact. The user is therefore able to carry the handset anywhere for listening to music.

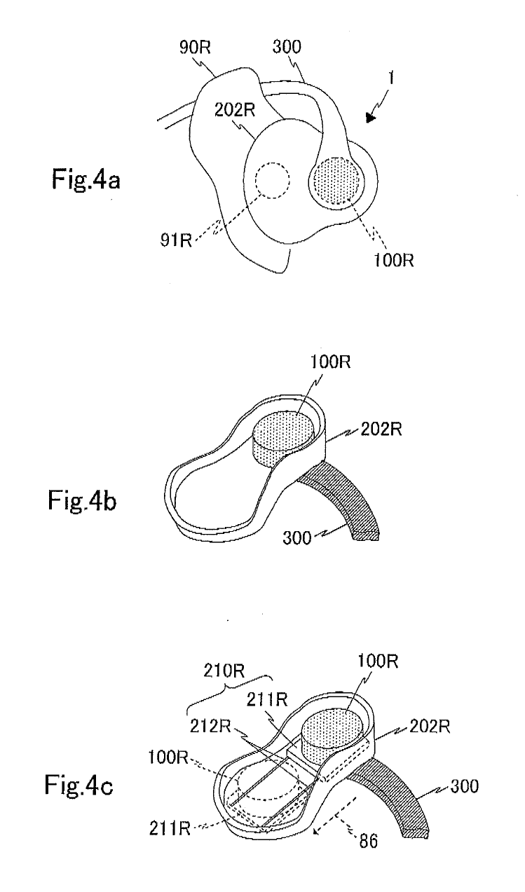

Modifications to the above-described structure will now be described. FIGS. 4a and 4b show, in combination, one modification. FIG. 4a depicts the right ear 90R and its vicinity when the headset 1 having a diaphragm 202R different from the above-described diaphragms is worn on the head. FIG. 4b is a perspective view of the vibrator 100R, the diaphragm 202R, and the linking unit 300 of the headset 1 of FIG. 4a viewed from the user's head side.

The diaphragm 202R expands in the direction away from the vibrator mounting position. The expanded portion of the diaphragm 202R covers (extends next to) the right ear 90R. This portion is enlarged as compared to the diaphragm 200R of FIG. 3a. By having such shape, external noises are more reduced and a user can concentrate on listening to music. Since the ambient noises to the ears are reduced, a user can listen to music at a lower sound volume. As a result, sound leakage to the outside from the headset can be reduced, and power consumption can also be reduced.

FIG. 4c shows another modification. A sliding mechanism 210R is provided on the vibrator 202R (FIG. 4a) for adjusting the position of the vibrator 100R on the diaphragm 202R. The phantom line vibrator 100R indicates when the solid line vibrator 100R is moved by means of the sliding mechanism 210R, as indicated by the arrow 86. The sliding mechanism 210R has a slide plate 211R and a pair of rails 212R. The slide plate 211R moves along the rails 212R. The vibrator 100R is mounted on the plate 211R. For example, the vibrator 100R and plate 211R can take any position between opposite ends of the rails 212R (i.e., between the position shown by the solid line 100R and the position shown by the phantom line 100R). It should be noted that the rails 212R may be grooves, and the slide plate 221R has protruding members that are slidably received in the grooves. The sliding mechanism 210R may be able to stop the vibrator 100R and plate 211R at the solid line position and the phantom line position (and also at other positions in-between). For stoppage of the slide plate 211R on the rails 212R, the sliding mechanism 210R may be equipped with a latch mechanism (not shown), for example. The structure of FIG. 4c allows a user to change the positional relationship between the ear hole 91R (FIG. 4a) and the vibrator 100R. When the user wants to reduce the sound leakage to the environment from the headset, the slide plate 211R is moved together with the vibrator 1008 in the direction of arrow 86. By this sliding movement, the vibrator 100R becomes closer to the ear hole 91R so that the user can listen to music with a smaller volume.

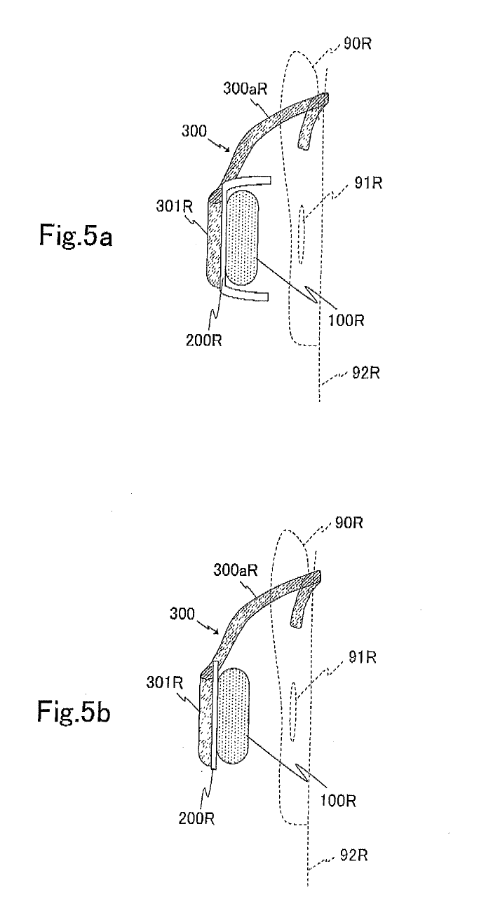

FIG. 5a shows another modification. FIG. 5a is a cross-sectional view of the right ear 90R and its vicinity when the headset 1 having the linking unit 300 different from the above-described linking unit is worn on the head. As depicted in FIG. 5a, the curved portion 300aR of the linking unit 300 may be configured to be bent at a certain angle toward the direction away from the head side surface 92R when the headset 1 is worn. With this configuration, the diaphragm 200R does not contact with the ear 90R, the ear canal 91R and user's side face 92R at all. FIG. 5b shows a modification to FIG. 5a. As illustrated in FIG. 5b, the diaphragm 200R may not be provided with the sidewall if the provision of the sidewall is unnecessary or undesired.

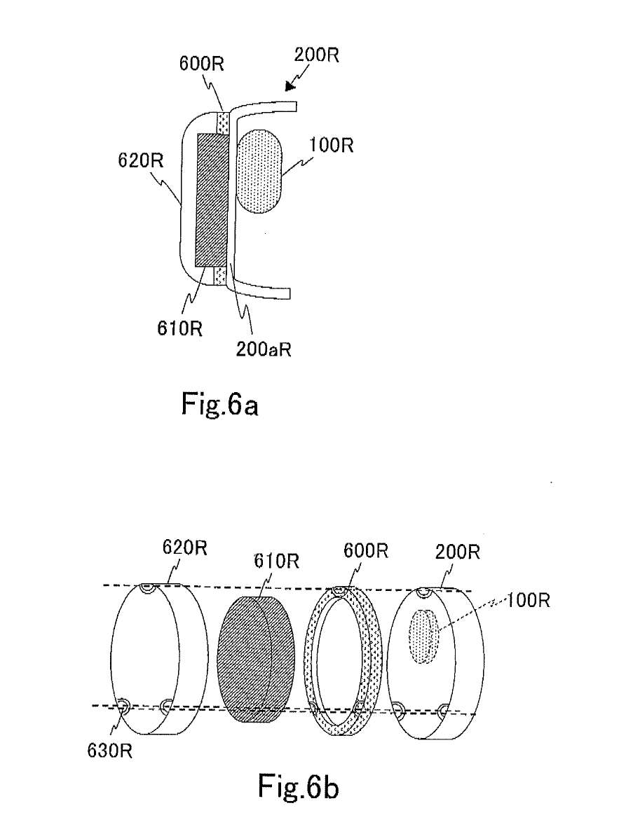

FIG. 6a illustrates yet another modification. FIG. 6a is a cross-sectional view of the diaphragm 200R with a sound absorbing member 610R. FIG. 6b is an exploded perspective view of FIG. 6a. The sound absorbing member 610R is attached to the outer surface of the base portion 200aR of the diaphragm 200R and is covered or concealed by an external case 620R. The external case 620R is screwed to the diaphragm 200R via a ring-shaped (or annular) rubber cushion 600R at positions indicated by the dotted lines in FIG. 6b, for example. Since high-frequency sound is generally more likely to leak than low-frequency sound, it is preferred to use, for example, thermosetting foam such as urethane or thermoplastic foam such as glass wool that attenuates high-frequency sound as the material of the sound absorbing member 610R.

### Second Embodiment

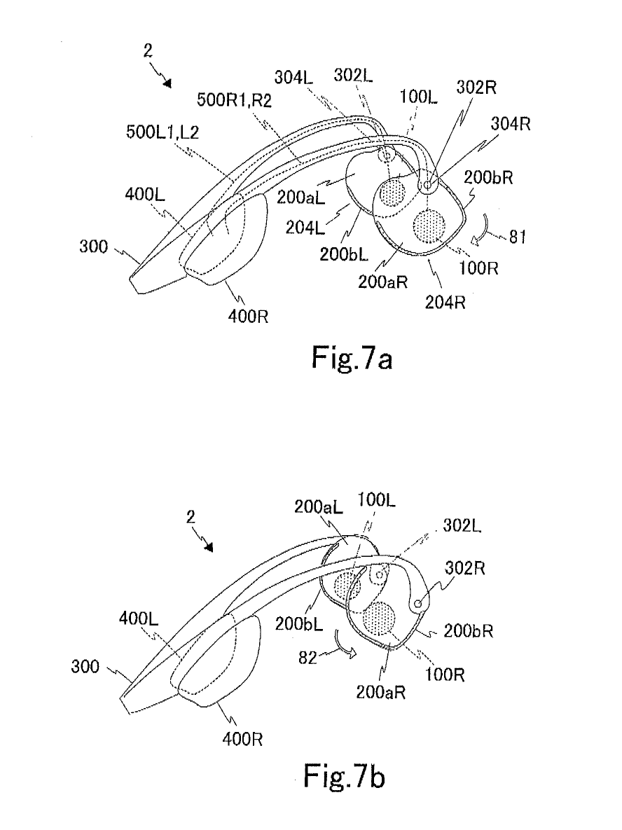

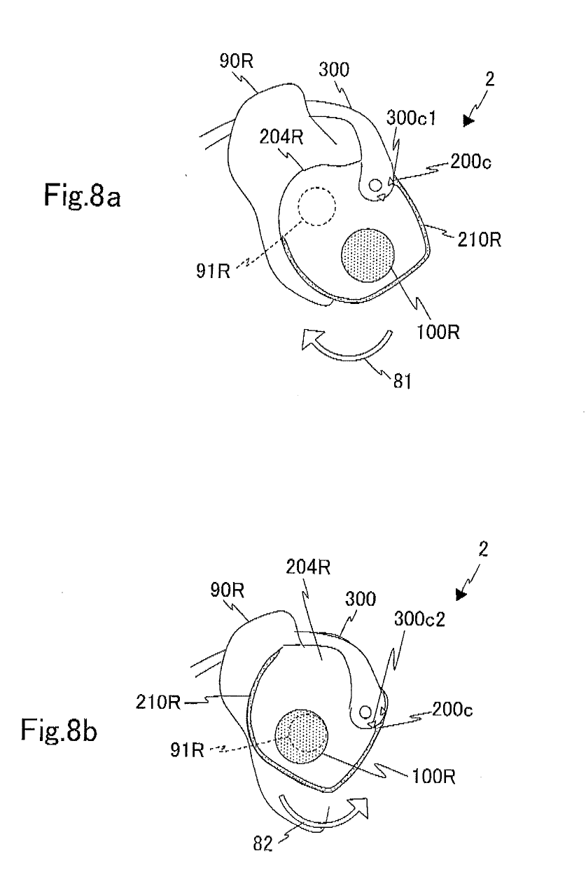

The second embodiment of the present invention will be described with reference to FIG. 7a to FIG. 8b. The headset 2 according to the second embodiment has movable diaphragms 204R and 204L.

FIG. 7a depicts the headset 2 with the movable diaphragms 204R and 204L in the open state (open position). FIG. 7b depicts the headset 2 with the diaphragms 204R and 204L in the closed state (closed position). The following description will primarily deal with differences between the first and second embodiments.

The diaphragm 204R is attached to one end of the linking unit 300 such that it can rotate in the directions indicated by the arrows 81 and 82 about the rotation shaft 302R. Likewise, the diaphragm 204L is attached to the other end of the linking unit 300 such that it can rotate in the directions indicated by the arrows 81 and 82 about a rotation shaft 302L. The sidewall 200bR is provided on a peripheral edge of the base portion 200aR of the diaphragm 204R except a predetermined portion thereof. A similar sidewall 200bL is provided on a peripheral edge of a base portion 200aL of the diaphragm 204L. Like the first embodiment, the sidewalls 200bR and 200bL stand on the user's head side (not depicted).

The diaphragms 204R and 204L of the headset 2 can mechanically be locked (latched) at least at the open position (FIG. 7a) and the closed position (FIG. 7b). A variable resistance 304R whose resistance value varies depending on the open/close position of the diaphragm 204R may be provided at the position of the rotation shaft 302R such that the electric signals from the signal amplifying unit 433 (FIG. 2) are supplied to the vibrator 100R via the metal wirings 500R1, 500R2, and the variable resistance 304R. The resistance value of the variable resistance 304R at the closed position is greater than the resistance value at the open position. With this configuration, a signal level of the electric signals supplied to the vibrator 100R in the closed state becomes lower than a signal level of the electric signals supplied to the vibrator 100R in the open state. As a result, a sound volume in the closed state becomes smaller than a sound volume in the open state.

It should be noted that each of the diaphragms 204R and 204L may be configured to be latchable at a plurality of positions (e.g., at three positions) between the open position and the closed position at regular intervals. In this case, each diaphragm can take five positions. The resistance value of the right variable resistance 304R is set to increase stepwise as the diaphragm position comes closer to the closed position from the open position. With such configuration, a signal level of the electric signals supplied to the vibrator 100R is reduced stepwise as the position comes closer to the closed position from the open position. As a result, a sound volume is reduced stepwise as the diaphragm position comes closer to the closed position from the open position. A variable resistance 304L for changing a sound volume of the left vibrator 100L has the same configuration as the right variable resistance.

FIG. 8a illustrates the right ear 90R and its vicinity when the headset 2 of FIG. 7a is worn on the head in the open state. FIG. 8b illustrates the headset 2 of FIG. 7b when it is worn on the head in the closed state.

In the open state, as depicted in FIG. 8a, a claw 200c provided at the edge of the diaphragm 204R is hooked on a protrusion 300c1 formed at the end of the linking unit 300 to fix (latch) the diaphragm 204R in the open position. In the closed state, as depicted in FIG. 8b, the claw 200c is hooked on a protrusion 300c2 formed at the end of the linking unit 300 to latch the diaphragm 204R in the closed position.

In the open state depicted in FIG. 8a, the vibrator 100R is located on the obliquely lower side of the right ear canal 91R. The ear canal 91R is covered by that portion of the diaphragm 204R which does not have the sidewall 200bR. The diaphragm 204R extends at a position spaced from the ear canal 91R (or the user's side face 92R) by a certain distance. The sound volume is greater as compared to the closed state.

In the open state, since the diaphragm 204R covers (extends over) the immediate lateral side of the ear canal 91R, music can be listened to at high quality. Since the sidewall 200bR does not exist on the periphery of the ear canal 91R, external sound can sufficiently be heard.

In the closed state depicted in FIG. 8b, the vibrator 100R is located on the immediate lateral side of the ear canal 91R. As compared to the open state, a greater area of the ear 90R is covered by that portion of the diaphragm 204R which has the sidewall 200bR. The vibrator 100R and the diaphragm 204R are located at a position separated from the ear canal 91R by a certain distance. The sound volume becomes smaller as compared to the open state, if no manual adjustment is made to the sound volume.

In the closed state, since the vibrator 100R is located immediately next to the ear canal 91R, music can be listened to at high quality even at a smaller sound volume as compared to the open state. Since the sidewall 200bR exists on the periphery of the ear canal 91R, sound leakage to the outside can be reduced.

The left diaphragm 204L extends next to the immediate lateral side of the left ear canal in the open state and the left vibrator 100L is located immediately next to the left ear canal in the close state. Thus, the left diaphragm 204L achieves the same advantages as the right diaphragm 204R.

It should be noted that the diaphragm 204R may be latched at one or more positions between the open position and the closed position by further forming at least one additional protrusion (not shown) between the protrusion 300c1 and the protrusion 300c2. In this case, the diaphragm position and the sound volume can be adjusted at three or more levels.

### Third Embodiment

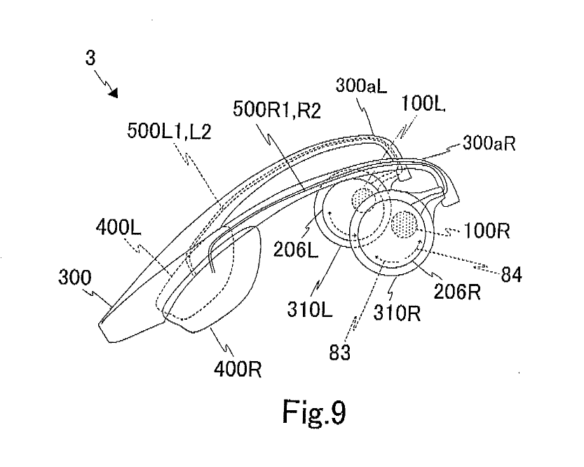

The third embodiment of the present invention will now be described. FIG. 9 shows a headset 3 of the third embodiment. Portions different from the first and second embodiments will hereinafter mainly be described.

A ring-shaped (or annular) unit 310R is disposed at one end of the linking unit 300. A circular-shaped diaphragm 206R is fit into the ring of the annular unit 310R such that the diaphragm is able to rotate in the annular unit in the directions indicated by the arrows 83 and 84 about the center of the circular shape. The vibrator 100R is fixed to the inner surface of the diaphragm 206R, i.e., on the side facing the head when the headset is worn. Specifically, the vibrator 100R is fixed at a position offset from the center of the circular diaphragm 206R, and the position is moved by the rotation of the diaphragm 206R. A user can touch and rotate the diaphragm 206R with fingers. The diaphragm 206R may have grooves on its outer surface for finger friction (not depicted) to facilitate the rotation of the diaphragm 206R. The annular unit 310R is fixed at the end of the linking unit 300 such that the annular unit 310R is on the outer side of the curved portion 300aR coming into contact with the head side surface 92R when the headset 3 is worn, i.e., to be located in the direction away from the head side surface 92R. Therefore, the right annular unit 310R does not contact with the right side surface 92R of the user's head when the headset 3 is worn.

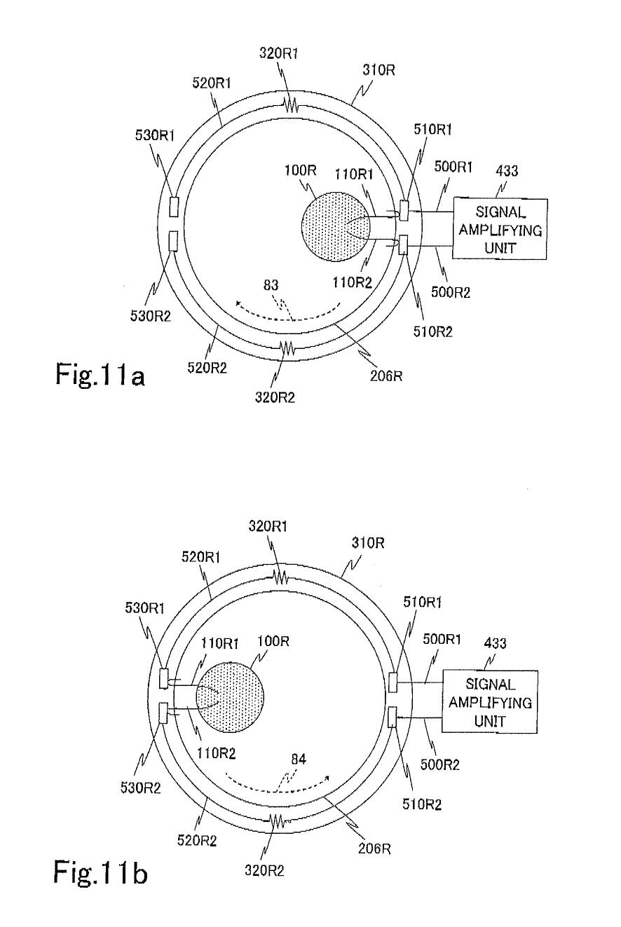

The linking unit 300 has therein the metal wirings 500R1 and 500R2 that connect terminals 510R1 and 510R2 (FIG. 11a) disposed in the annular unit 310R to the signal supplying unit 430 (FIG. 2) housed in the control unit 400R. A left annular unit 310L and a diaphragm 206L are disposed at the other end of the linking unit 300 in the same way as the right annular unit 310R. The metal wirings 500L1 and 500L2 for the left diaphragm 206L extend in the linking unit 300 in the same way as the wirings 500R1 and 500R2.

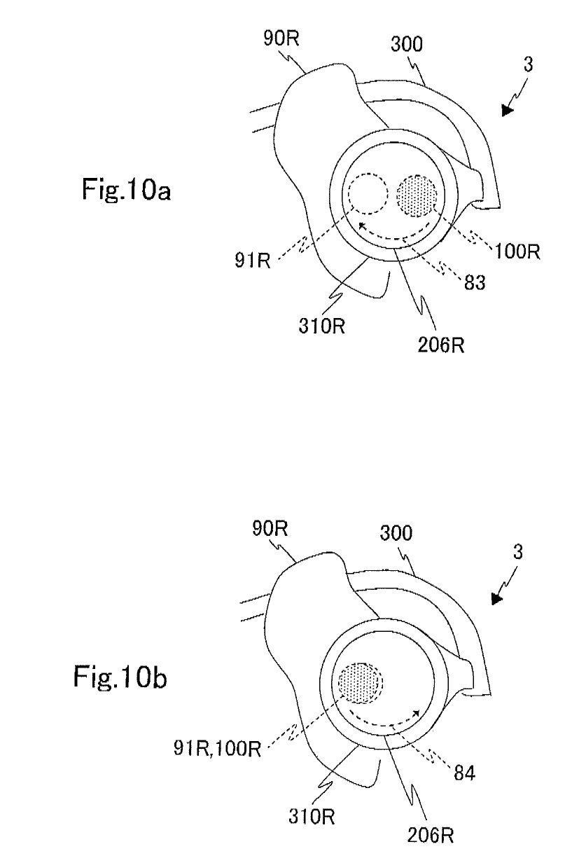

FIG. 10a shows the right ear 90R and its vicinity when the headset 3 of FIG. 9 is worn on the head. This state is referred to as a first state. FIG. 10b shows the headset 3 of FIG. 9 in a second state. In the first state, the vibrator 100R is located at a position displaced from the ear canal 91R toward the front side of the head. The circular-shaped diaphragm 206R does not entirely cover the ear 90R, and only part thereof extends next to the ear canal 91R. The diaphragm 206R is spaced from the ear canal 91R (or user's side face 92R) by a certain distance. Rotating the diaphragm 206R in the direction of the arrow 83 results in the second state depicted in FIG. 10b. In the second state, the vibrator 100R is located on the immediate lateral side of the ear canal 91R. The vibrator 100R is spaced from the ear canal 91R (or user's side face 92R) by a certain distance. The circular-shaped diaphragm 206R does not entirely cover the ear 90R, and only part thereof covers the immediate lateral side of the ear canal 91R in the second state. This is the same as the first state.

FIG. 11a is a diagram useful to explain sound volume control in the first state of the headset 3 of FIG. 9. FIG. 11b is a diagram of the sound volume control in the second state.

The terminal 510R1 and a terminal 530R1 are disposed inside the annular unit 3108. The terminal 510R1 and the terminal 530R1 are connected to each other by a metal wiring 520R1 via a resistor 320R1. The terminal 510R2 and a terminal 530R2 are disposed adjacently to the terminal 510R1 and the terminal 530R1, respectively, inside the annular unit 310R. The terminal 510R2 and the terminal 530R2 are connected to each other by a metal wiring 520R2 via a resistor 320R2.

The terminal 510R1 and the terminal 510R2 are connected to the signal amplifier 433 of the signal supplying unit 430 (FIG. 2) via the metal wiring 500R1 and the metal wiring 500R2, respectively.

The vibrator 100R is connected to contact terminals 110R1 and 110R2. In the first state, as shown in FIG. 11a, the contact terminal 110R1 and the contact terminal 110R2 contact with the terminal 510R1 and the terminal 510R2, respectively. Therefore, in the first state, the signal amplifying unit 433 supplies the vibrator 100R with electric signals not attenuated by the resistors 320R1 and 320R2. As a result, a sound volume is relatively large in the first state.

In the second state, as shown in FIG. 11b, the contact terminal 110R1 and the contact terminal 110R2 contact with the terminal 530R1 and the terminal 530R2, respectively. Therefore, in the second state, the signal amplifying unit 433 supplies the vibrator 100R with electric signals attenuated by the resistors 320R1 and 320R2. As a result, a sound volume is relatively small in the second state.

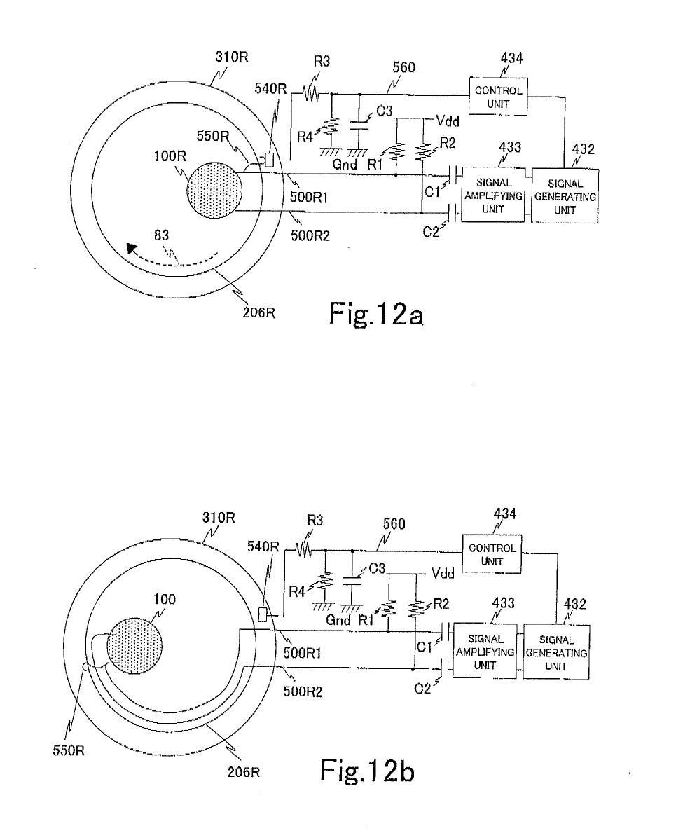

FIG. 12a illustrates another sound volume control in the first state of the headset 3 of FIG. 9. FIG. 12b illustrates another sound volume control in the second state.

The vibrator 100R is connected to the signal amplifying unit 433 by the metal wiring 500R1 via a capacitance C1 and by the metal wiring 500R2 via a capacitance C2. The capacitance C1 and C2 cut out direct-current components of the electric signals from the signal amplifying unit 433. The metal wiring 500R1 is connected with a resistance R1 having one end connected to a power supply voltage Vdd, and the metal wiring 500R2 is connected with a resistance R2 having one end connected to the power supply voltage Vdd. The resistances R1 and R2 apply a direct-current bias to the vibrator 100R. A resistance value of each of the resistances R1 and R2 is a far greater value as compared to the input impedance of the vibrator 100R so as to minimize the effect on the electric signals from the signal amplifying unit 433.

The metal wiring 500R1 is connected with a branch wiring 550R. As shown in FIG. 12a, in the first state, the branch wiring 550R contacts with a terminal 540R disposed inside the annular unit 310R. The terminal. 540R is connected to an A/D (analogue/digital) conversion input of a control unit 434 by a wiring 560 via a resistance R3. The control unit 434 is included in the signal supplying unit 430 shown in FIG. 2. The wiring 560 is connected with a resistance R4 and a capacitance C3. The other end of the resistance R4 is connected to aground potential Gnd, and the other end of the capacitance C3 is connected to the ground potential Gnd. The resistance R4 and the capacitance C3 smooth an analogue signal from the terminal 540.

As illustrated in FIG. 12a, in the first state, since the branch wiring 550R contacts with the terminal 540R, the control unit 434 reads the bias voltage via the resistor R3 and detects that the diaphragm 206R is in the first state. As shown in FIG. 12b, in the second state, since the branch wiring 550R does not contact with the terminal 540R, 0 V (ground potential) is introduced through the resistance R4 to the A/D conversion input of the control unit 434. As a result, the control unit 434 detects that the diaphragm 206R is in the second state. In this manner, the control unit 434 determines that the first state is achieved when the bias voltage is introduced and determines that the second state is achieved when 0 V (ground potential) is introduced.

The control unit 434 instructs the signal generating unit 432 to increase the sound volume when the control unit determines that the first state is achieved, and instructs the signal generating unit 432 to reduce the sound volume when it determines that the second state is achieved. Although the vibrator 100R exists at a position offset from the ear canal 91R toward the front side of the head in the first state, the sound volume is set relatively large and, therefore, music can be listened to at a sufficient sound volume. Since the vibrator 100R exists immediately adjacent to the ear canal 91R in the second state, a relatively small volume is sufficient and the sound leakage to the outside can be reduced by setting the sound volume relatively small.

The control unit 434 can give instructions to the signal generating unit 432 with regard to, for example, changes in frequency characteristics along with the sound volume change depending on the first and second state. The control unit 434 gives, for example, values of setup parameters for the sound volume and the frequency characteristics to the signal generating unit 432 to control or adjust the sound volume and the frequency characteristics. The diaphragm 206L, the annular unit 310L, and associated wirings for the left ear are configured in the same way as the above-described configuration of the right diaphragm 2068, the annular unit 310R, and associated wirings. The vibrators 100R and 100L make no contact with the head as is the case with the first embodiment.

### Fourth Embodiment

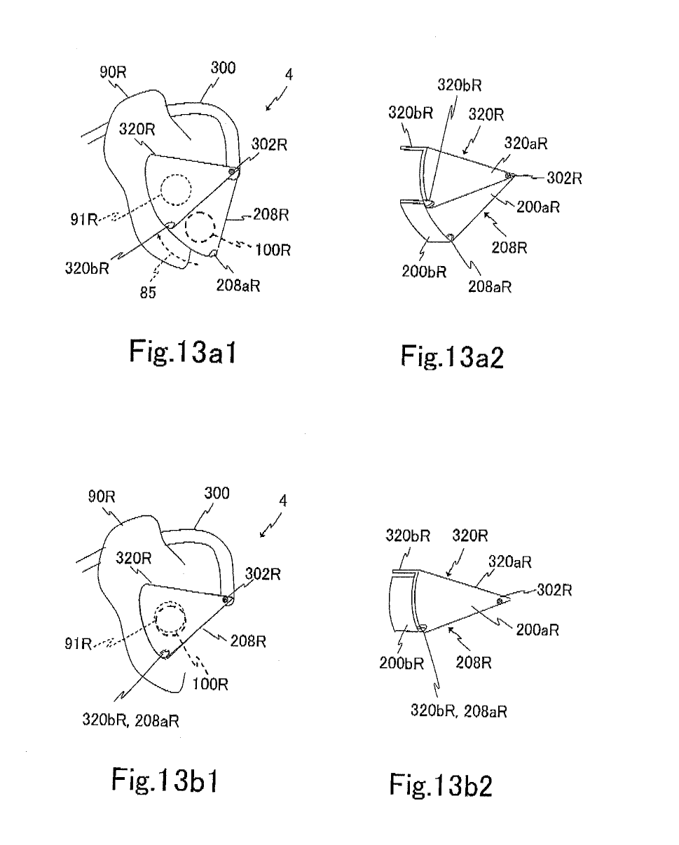

The fourth embodiment of the present invention will be described below. FIG. 13a1 illustrates a headset 4 of this embodiment in the open state. FIG. 13a2 is a perspective view of a diaphragm 206R and a lid unit 320R in the open state. FIG. 13b1 depicts the headset 4 in the closed state. FIG. 13b2 is a perspective view of the diaphragm 208R and the lid unit 320R in the closed state. Portions different from the first to third embodiments will hereinafter mainly be described.

The lid unit 320R is firmly fixed to one end of the linking unit 300 in an immovable manner. The lid unit 320R serves as a member for preventing sound leakage. When the headset 4 is worn on the head, the lid unit 320R covers the ear canal 91R. The lid unit 320R has a base portion 320aR and a sidewall 320bR. A shape of the base portion 320aR is a fan shape as shown in FIGS. 13a1 and 13a2, for example. One side of the fan shape of the base portion 320aR has the sidewall 320bR for guiding sound to the ear canal 91R. No side wall is formed on the opposite side of the fan shape. The base portion 320aR has a notch 320bR for receiving (engaging) a protrusion 208aR of the diaphragm 208R in the open state.

The diaphragm 208R is attached to one end of the linking unit 300 such that the diaphragm is able rotate about the shaft 302R. The diaphragm 208R has the base portion 200aR and the sidewall 200bR. A shape of the base portion 200aR is a fan shape slightly smaller than the base portion 320aR of the lid unit 320R as shown, in FIGS. 13a1 and 13a2. The sidewall 200bR is formed on one side and an arc portion of the fan shape of the base portion 200aR. No side wall is formed on the opposite side of the fan shape. The vibrator 100R is fixed to the inner surface of the base portion 200aR (the surface on the side with the sidewall 200bR formed). Specifically, the vibrator 100R is fixed at a position near the arc of the fan shape and can change its position between the open state (open position) and the closed state (closed position). The base portion 200aR has the protrusion 208aR formed to fit into the notch 320bR of the lid unit 320R in the open state.

The diaphragm 208R rotates around the shaft 302R to achieve the open state or the closed state. In the open state (FIGS. 13a1 and 13a2), only the lid unit 320R covers the immediate lateral side of the ear canal 91R. The base portion 320aR of the lid unit 320R is spaced from the ear canal 91R (or user's side face 92R) by a certain distance. The diaphragm 208R and the vibrator 100R are located at a position on the front obliquely lower side of the head from the ear canal 91R. As shown in FIG. 13a2, the sidewall 200bR of the diaphragm 208R and the sidewall 320bR of the lid unit 320R do not contact with each other. In this positional relationship, the vibrations of the vibrator 100R are guided to the ear canal 91R by the lid unit 320R and the diaphragm 208R while external sound is introduced to the ear canal 91R through the gap formed between the sidewall 320bR and the sidewall 200bR.

The diaphragm 208R is fixed at the closed position by rotating the diaphragm 208R in the direction of the arrow 85 and fitting the protrusion 208aR of the diaphragm 208R into the notch 320bR of the lid unit 320R. In the closed state (FIGS. 13b1 and 13b2), the vibrator 100R is located at the immediate lateral side of the ear canal 91R. The base portion 200aR of the diaphragm 208R and the vibrator 100R are spaced from the ear canal 91R (or user's side face 92R) by a certain distance. Since the vibrator 100R and the ear canal 91R are surrounded (encapsulated) by the sidewall 320bR of the lid unit 320R and the sidewall 200bR of the diaphragm 208R as shown in FIG. 13a2, the external sound can be shut off; it is possible to listen to music at high quality and the sound leakage to the outside can be prevented.

Although the description has been made of the diaphragm 208R and the lid unit 320R on the right side, the same configuration is also employed on the left side. It should be noted that the diaphragm 208R has the two positions (closed position and open position) in the foregoing description, but the diaphragm may have one or more additional stop positions between the open and closed positions.

### Fifth Embodiment

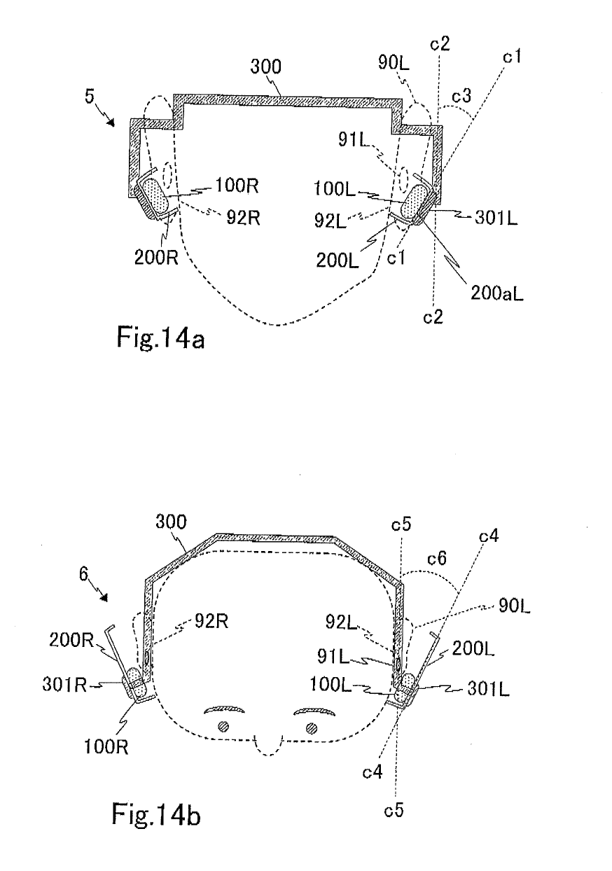

The fifth embodiment of the present invention will be described with reference to FIG. 14a. FIG. 14a shows a headset 5 according to the fifth embodiment as viewed from the front of the user's head. The headset 5 has the diaphragms 200L and 200R of FIG. 3a that are tilted relative to the head side surfaces 92L and 92R when the headset is worn. The following description primarily deals with the differences as compared with the first to fourth embodiments.

As seen in FIG. 14a, the diaphragm 200L of the headset 5 is fixed to the linking unit 300 such that the axis c1-c1 parallel to the base portion 200aL intersects at a predetermined angle c3 (e.g., 45 degrees) with an extension axis c2-c2 of the linking unit 300 extending in the direction normal to the ground when the headset is worn.

The headset 5 has the vibrator 100L perpendicularly directed to the ear canal 91L when the headsets are worn. Since this causes the vibrations of the vibrator 100L to more directly or straightly reach the ear canal 91L through the medium of air, music can be listened to even at a relatively low sound volume with high quality. The right diaphragm 200R is attached to the linking unit 300 in the same way as the left diaphragm 200L, and achieves the same effects as the left diaphragm 200L.

FIG. 14b shows a modification to FIG. 14a. Specifically, FIG. 14b illustrates another headset 6 having the diaphragms 200L and 200R of FIG. 3a tilted relative to the head side surfaces 92L and 92R when the headset is worn, as viewed from the top of the head.

As shown in FIG. 14b, the diaphragm 200L of the headset 6 is fixed to the linking unit 300 such that the axis c4-c4 parallel to the base portion 200aL intersects at a predetermined angle c6 (e.g., 45 degrees) with an extension axis c5-c5 of the linking unit 300 extending in the direction parallel to the ground when the headset is worn.

The headset 6 has the vibrator 100L perpendicularly directed to the ear canal 91L when the headsets are worn. Since this causes the vibrations of the vibrator 100L to more directly or straightly reach the ear canal 91L through the medium of air, music can be listened to even at a relatively low sound volume with high quality. The right diaphragm 200R is attached to the linking unit 300 in the same way as the left diaphragm 2001, and achieves the same effects as the left diaphragm 200L.

The headset of FIG. 14a or 14b may be particularly useful when that portion of the linking unit 300 from the corner 300aR to the diaphragm mounting position 302R is longer than the length shown in FIG. 3a and the vibrator 100R is located on the front oblique lower side of the head when compared with the location in FIG. 3a.

### Sixth Embodiment

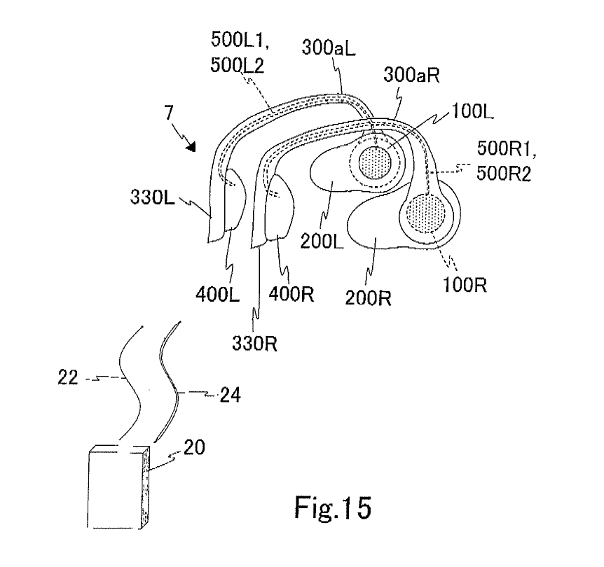

The sixth embodiment of the present invention will be described with reference to FIG. 15. This drawing illustrates a perspective view of a headset 7 according to the sixth embodiment. The following description primarily deals with the differences between the first embodiment (FIG. 1) and the sixth embodiment.

The headset 7 has two separate holding units 330R and 330L. The right holding unit 330R supports the right diaphragm 200R, and the left holding unit 330L supports the left diaphragm 200L. Unlike the first embodiment, the two diaphragms 200R and 200L are not connected to each other. In this embodiment, the bent part 300aR of the right holding unit 330R looks on the user's right ear, and the bent part 300aL of the left holding unit 330L looks on the user's left ear. When the user wears the right holding unit 330R (FIG. 3a), the diaphragm 200R associated with the holding unit 330R is supported at a position spaced from the user's right head side 92R as shown in FIG. 3b1. Likewise, when the user wears the left holding unit 330L, the diaphragm 200L associated with the holding unit 330L is supported at a position spaced from the user's left head side.

In this manner, the right and left diaphragms of the headset of the invention are not necessarily connected to each other. The combination of the right diaphragm and right holding unit may be independent from the combination of the left diaphragm and left holding unit, as shown in FIG. 15. In the sixth embodiment, the user does not have to wear the right holding unit 330R and the left holding unit 330L at the same time. In one occasion, the user may wear only the right holding unit 330R on his right ear.

### Configuration of Vibrator

FIG. 16 is a cross-sectional view of the vibrator 100R included in each of the headsets 1 to 7 of the first to sixth embodiments. FIG. 17 is an exploded cross-sectional view showing the respective parts of the vibrator 100R of FIG. 16. The vibrator 100R includes an upper frame half 101, a movable support 102, a yoke 103, a magnet 104, a weight 105, a coil 106, a lower frame half 107, and a vibrator diaphragm 108. The upper frame half 101 is joined to the lower frame half 107 to make a single frame 109. This frame 109 serves as a housing for the magnet 104 and associated elements and parts.

The upper frame half 101 is, for example, a dish-shaped casing half made of a suitable material such as plastic. An opening 101a is made at the center of the upper frame half 101 so as to limit (adjust) the movement of the magnet 104 to some extent. The opening 101a provides the same effect as an air duct of a speaker box. This improves the sound quality. The upper frame half 101 has a plurality of mounting portions 101b for fixing the movable support 102 at regular intervals along the outer circumference of the upper frame half 101, for example.

The lower frame half 107 is also a dish-shaped casing element made of, for example, a material such as plastic. An opening 107a is made at the center of the lower frame half 107, and an annular protrusion 107b is provided to surround the opening 107a. A vibrator diaphragm 108 is fit into the annular protrusion 107b to close the opening 107a of the lower frame half 107.

A combined frame structure made by coupling the upper frame half 101 and the lower frame half 107 with an adhesive or a mechanical joint such as physical engagement is referred to as the frame 109. The lower frame half 107 is curved from the opening 107a toward an edge 107c of the dish shape. Since the outer shape of the lower frame half 107 bends, stable contact can be achieved with any head shapes. It should be noted that as shown in FIG. 3b1, the vibrator 100R (more specifically, the lower frame half 107) may not be allowed to contact with the head. A thickness of the frame 109 is not limited to the one illustrated. The frame thickness may be decided in accordance with product specifications. Decorations and other structures may be provided on the outer surface of the frame 109 as needed.

The movable support 102 is a support member for coupling and fixing the yoke 103 to the upper frame half 101. Also the movable support 104 serves as a damper. The movable support 104 is made by punching a metal plate, for example, a copper plate by press. The movable support 102 has, for example, an annular structure at its center area to receive the yoke 103 therein. A plurality of fixing portions 102a is provided along (in) an outer extension of the annular structure, for example, at regular intervals. Each of the fixing portions 102a is fixed to the corresponding mounting portion 101b of the upper frame half 101 by a fixing pin or screw 110. The yoke 103 is fixed to the movable support 102, and the yoke can move up and down toward the upper frame half 101 and the lower frame half 107 due to flexure of the movable support 102. In particular, acoustic characteristics are improved by disposing the fixing portions 102a at the positions extended from the annular structure of the movable support 102 and coupling the fixing portions 102a to the mounting portions 101b of the upper frame half 101.

The yoke 103 has a cylindrical shape having a bottom (or a pot shape), and is an iron yoke made of a magnetic metal, for example, soft iron. The yoke is supported inside the frame or housing 109 by being fit into the annular portion of the movable support 102 with its bottom 103b facing toward the upper frame half 101. The side wall of the yoke 103 is provided with a ring-shaped protrusion 103a, and this protruding portion 103a is bonded and fixed to the movable support 102. The position of the protrusion 103a on the side surface of the yoke 103 is not limited to the illustrated position, but may be decided in accordance with the shape of the frame 109 and/or other given conditions. The bottom 103b of the yoke 103 is flat such that the magnet 104 can be affixed to the bottom 103b in the illustrated embodiment.

The magnet 104 is a column-shaped permanent magnet having a predetermined magnetic property. One face of the magnet 104 is fixed at the approximate center of the bottom 103b of the yoke 103 with an adhesive. A diameter of the magnet 104 is smaller than a diameter of the bottom 103b of the yoke 103 and a ring-shaped space exists between the side surface of the fixed magnet 104 and the sidewall of the yoke 103. The magnet face fixed to the bottom 103b of the yoke 103 may be either on the S-polarity side or on the N-polarity side of the magnet 104. For example, the S-polarity face of the magnet 104 is fixed to the bottom 103b of the yoke 103.

The weight 105 has a column shape. The weight 105 has substantially the same diameter as the diameter of the magnet 104, and one face thereof is affixed to the other face of the magnet 104 with an adhesive. The weight 105 is of a magnetic body such as ferric oxide (iron oxide), chrome oxide, cobalt, or ferrite, for example. It should be noted that the diameter of the weight 105 is normally the same as the diameter of the magnet 104, but the weight 105 may be made larger or smaller than the magnet, if needed.

By changing the size (and/or mass) of the weight 105, the substantive mass of the magnet 104 can be changed. For example, the mass can be changed by increasing or decreasing the thickness of the weight 105 in the column axis direction. If the substantive mass of the magnet 104 is changed, the frequency characteristics of vibrations and the sound quality are changed. Therefore, by changing the size (and/or mass) of the weight 105 for each product type, the frequency characteristics and the sound quality can easily be changed. The mass may be changed by affixing one or more additional weights to the weight 105.

The coil 106 is a so-called voice coil having a cylindrical shape. One end of the coil surrounds at least part of the side surfaces of the magnet 104 and the weight 105, and the other end is fixed to the vibrator diaphragm 108 as shown in FIG. 16, for example. The coil 106 is formed by winding an electric wire (e.g., copper wire) for a predetermined number of times around at least a portion of a cylindrical bobbin 106b made of, for example, a material such as plastic or aluminum to acquire a predetermined inductance. This portion will hereinafter be referred to as winding 106a. It should be noted that a resin-enveloping (or sealing) process may be performed to embed and fix, by resin, the electric wire 106a around the bobbin 106b.

The winding 106a is provided at an end of the bobbin 106b closer to the magnet 104 as depicted in FIGS. 16 and 17, for example. At least part of the winding 106a extends along (in) the ring-shaped space formed between the side surfaces of the magnet 104 and the weight 105, and the sidewall of the yoke 103. An end opposite to the winding portion 106a (hereinafter, a fixing portion 106c) is fixed to the vibrator diaphragm 108. The fixing portion 106c is fixed to the vibrator diaphragm 108 by, for example, a mechanical mechanism (not shown; such as a fitting mechanism or an engaging mechanism) disposed on each of the fixing portion 106c and the vibrator diaphragm 108.

Since the thicknesses of the magnet 104 and the weight 105 in the column axis direction may be adjusted to obtain desired frequency characteristics and sound quality, the winding 106a may surround only part of the side surface of the weight 105 in some cases or may surround at least part of the side surface of the magnet 104 and the entire side surface of the weight 105 in other cases. From the viewpoint of effectively obtaining the effect of a magnetic field, a height h1 of the sidewall of the yoke 103 is preferably greater than a sum of a thickness d1 of the magnet 104 in the column axis direction and a thickness d2 of the weight 105 in the column axis direction.

The coil 106 is connected to wire codes (not shown) through a through-hole (not shown) made in the upper frame half 101, for example. When the coil 106 is supplied with electric power through the wire codes, the magnet 104 and the coil 106 vibrate at a predetermined or desired frequency because of the effect of the magnetic field generated between the magnet 104 and the coil 106.

The vibrator diaphragm 108 is, for example, a circular diaphragm made of a material such as plastic or aluminum. The vibrator diaphragm 108 has a diameter slightly larger than the diameter of the cylindrical coil 106. The vibrator diaphragm fits in the annular protrusion 107b that surrounds the opening 107a of the lower frame half 107. The winding portion 106a of the coil 106 is fixed to one surface of the vibrator diaphragm 108. A thickness of the vibrator diaphragm 108 may be decided on the basis of given conditions such as the material of the vibrator diaphragm.

The vibrator 100R is fixed to the diaphragm 200R with, for example, an adhesive with the upper frame half 101 facing the diaphragm 200R (FIG. 3c). The left vibrator 100L has the same configuration as the right vibrator 100R, and is fixed to the left diaphragm 200L (FIG. 1 or FIG. 14a) in the same way as the right vibrator 100R.

When the coil 106 is supplied with an electric current for generating vibrations corresponding to, for example, sound such as music through the wire codes (not shown), the magnet 104 and the coil 106 vibrate at a frequency corresponding to an amount of the current and a total mass of the magnet 104 and the weight 105 because of the effect of the magnetic field generated between the magnet 104 and the coil 106. The magnet 104 fixed to the bottom 103b of the yoke 103 mainly vibrates along the direction of the column axis thereof due to the flexure of a foot portion 102b of the movable support 102. The coil 106 mainly vibrates along the direction of the cylindrical axis thereof and the vibrations are transmitted to the vibrator diaphragm 108 fixed to the coil 106 through the fixing portion 106c. These vibrations are also transmitted to the diaphragm 200R to which the vibrator 100R is fixed. The vibrations of the vibrator 100R are transmitted from the vibrator diaphragm 108 and the diaphragm 200R to the ear canal 91R (FIG. 3b2) through the medium of air.

The vibrator 100R has the diaphragm on the coil side, and the coil side faces the head when the headset is worn. The vibrator 100R fixes the yoke 103, to which the magnet is fixed, to a frame with the movable support 102. With the configuration, the vibrator 100R can vibrate substantially uniformly over a wide frequency band in spite of small size. Therefore, high-quality sound reproduction can be achieved over a wide band from the low-tone range to the high-tone range.

It is possible to affix the weight 105 to one surface of the magnet 104 (surface on which the coil is disposed) in this invention. By changing a size and/or a mass of the weight 105 for each product type, the mass of the magnet 104 can be changed in effect. Thus, it is possible to easily adjust and realize the frequency characteristics and sound quality as required for the product. This contributes to a considerable cost reduction.

With the vibrator configuration of the present invention, a relationship can arbitrarily be set between a height of the sidewall of the pot-shaped yoke and thicknesses of the column-shaped magnet and the weight affixed thereto. From the viewpoint of effectively acquiring the effect of the magnetic field, it is preferred that the height of the yoke sidewall is greater than a sum of the thickness of the magnet and the thickness of the weight.

What is claimed is:

1. A headset comprising:
at least one vibrator configured to vibrate in accordance with an electric signal;
at least one diaphragm each being associated with the respective vibrator; and
a holding unit that, when worn on a head of a user, holds the diaphragm such that at least part of the diaphragm is spaced from a side surface of the head by a predetermined distance.

2. The headset of claim 1, wherein the diaphragm extends over an immediate lateral side of an ear canal of the user when the headset is worn on the head of the user.

3. The headset of claim 1, wherein the vibrator is fixed to the diaphragm and is located at a position offset from an immediate lateral side of an ear canal of the user toward a front of the head of the user when the headset is worn on the head of the user.

4. The headset of claim 1, wherein the vibrator is fixed on that surface of the diaphragm which faces a side surface of the head when the headset is worn on the head of the user.

5. The headset of claim 1, wherein the diaphragm has a base portion to support the vibrator and a sidewall formed along at least part of a peripheral edge of the base portion.

6. The headset of claim 5, wherein the sidewall has a first height in the vicinity of the vibrator and a second height in other parts of the sidewall, and the first height is greater than the second height.

7. The headset of claim 5, wherein the sidewall has a first height in the vicinity of the vibrator, and the first height is greater than a thickness of the vibrator.

8. The headset of claim 1, wherein the at least one diaphragm includes two diaphragms, the holding unit includes a linking member that links the two diaphragms, and the linking member has a shape that wraps around the head when worn on the head of the user.

9. The headset of claim 1, wherein the diaphragm is rotatable about a predetermined holding position of the holding unit.

10. The headset of claim 1, wherein the diaphragm is provided on the holding unit such that the diaphragm is rotatable about a predetermined part of the holding unit, and the vibrator is fixed at a position offset from the center of rotation of the diaphragm.

11. The headset of claim 9 further comprising a signal supplying unit that changes a signal level of the electric signal depending on a rotational position of the diaphragm.

12. The headset of claim 10 further comprising a signal supplying unit that changes a signal level of the electric signal depending on a rotational position of the diaphragm.

13. The headset of claim 1 further comprising a sound leakage preventing member attached to the holding unit, wherein the diaphragm is movable between at least two positions relative to the sound leakage preventing member, one of the two positions is a position where the diaphragm is closest to the sound leakage preventing member so that an ear of the user is covered by the sound leakage preventing member and the base portion and the sidewall of the diaphragm, and the other position is a position where the diaphragm is farthest from the sound leakage preventing member so that the ear of the user is not covered by the sound leakage preventing member and the base portion and the sidewall of the diaphragm.

14. The headset of claim 1 further comprising a sound absorbing member in contact with the diaphragm.

15. A vibrator used with the headset of claim 1, comprising:
a frame that includes a vibration transmitting plate, the frame having an inner wall;
a movable support;
a cylindrical yoke fixed to the inner wall of the frame by the movable support, the yoke having a bottom;
a magnet fixed to the bottom of the yoke, the magnet having a side surface; and
a coil that surrounds at least part of the side surface of the magnet at one end thereof, the coil being fixed to the vibration transmitting plate at the other end thereof.

16. The vibrator of claim 15 further comprising a weight affixed to the magnet.

17. The vibrator of claim 16, wherein the weight is a magnetic body.

18. The vibrator of claim 17, wherein a height of a sidewall of the yoke is greater than a sum of a thickness of the magnet and a thickness of the weight.
